(19) United States
(12) Patent Application Publication
(10) Pub. No.: US 2025/0046996 A1
(43) Pub. Date: Feb. 6, 2025

(54) ANTENNA STRUCTURE

(71) Applicant: Wistron NeWeb Corp., Hsinchu (TW)

(72) Inventors: Guan-Ren SU, Hsinchu (TW); Ying-Hsuan CHEN, Hsinchu (TW); Hsieh-Chih LIN, Hsinchu (TW)

(21) Appl. No.: 18/760,360

(22) Filed: Jul. 1, 2024

(30) Foreign Application Priority Data
Aug. 2, 2023 (TW) 112129013

(51) Int. Cl. H01Q 5/50; H01Q 5/328; H01Q 5/364

(52) U.S. Cl. CPC H01Q 5/50; H01Q 5/328; H01Q 5/364

(57) ABSTRACT

An antenna structure includes a feeding radiation element, a connection radiation element, a first radiation element, a second radiation element, a first shorting radiation element, a second shorting radiation element, and a carrier element. The feeding radiation element has a feeding point. The connection radiation element is coupled to the feeding radiation element. The first radiation element is coupled to the connection radiation element. The second radiation element is coupled to the connection radiation element. The second radiation element and the first radiation element substantially extend in opposite directions. The feeding radiation element and the connection radiation element are coupled through the first shorting radiation element to a first grounding point. The second shorting radiation element is adjacent to the second radiation element. The connection radiation element and the first radiation element are coupled through the second shorting radiation element to a second grounding point.

### CROSS REFERENCE TO RELATED APPLICATIONS

This application claims priority of Taiwan Patent Application No. 112129013 filed on Aug. 2, 2023, the entirety of which is incorporated by reference herein.

### BACKGROUND OF THE INVENTION

### Field of the Invention

The disclosure generally relates to an antenna structure, and more particularly, to a wideband antenna structure.

### Description of the Related Art

With the advancements being made in mobile communication technology, mobile devices such as portable computers, mobile phones, multimedia players, and other hybrid functional portable electronic devices have become more common. To satisfy consumer demand, mobile devices can usually perform wireless communication functions. Some devices cover a large wireless communication area; these include mobile phones using 2G, 3G, and LTE (Long Term Evolution) systems and using frequency bands of 700 MHz, 850 MHz, 900 MHz, 1800 MHZ, 1900 MHZ, 2100 MHz, 2300 MHz, and 2500 MHz. Some devices cover a small wireless communication area; these include mobile phones using Wi-Fi systems and using frequency bands of 2.4 GHz, 5.2 GHz, and 5.8 GHz.

Antennas are indispensable elements for wireless communication. If an antenna used for signal reception and transmission has insufficient operational bandwidth, it will tend to negatively affect the communication quality of the relative mobile device. Accordingly, it has become a critical challenge for designers to design a small-size, wideband antenna structure.

### BRIEF SUMMARY OF THE INVENTION

In an exemplary embodiment, the invention is directed to an antenna structure that includes a feeding radiation element, a connection radiation element, a first radiation element, a second radiation element, a first shorting radiation element, a second shorting radiation element, and a carrier element. The feeding radiation element has a feeding point. The connection radiation element is coupled to the feeding radiation element. The first radiation element is coupled to the connection radiation element. The second radiation element is coupled to the connection radiation element. The second radiation element and the first radiation element substantially extend in opposite directions. The feeding radiation element and the connection radiation element are coupled through the first shorting radiation element to a first grounding point. The second shorting radiation element is adjacent to the second radiation element. The connection radiation element and the first radiation element are coupled through the second shorting radiation element to a second grounding point. The feeding radiation element, the connection radiation element, the first radiation element, the second radiation element, the first shorting radiation element, and the second shorting radiation element are distributed over the carrier element.

### BRIEF DESCRIPTION OF DRAWINGS

The invention can be more fully understood by reading the subsequent detailed description and examples with references made to the accompanying drawings, wherein:

FIG. 1 is a flat view of an antenna structure according to an embodiment of the invention;

FIG. 2 is a perspective view of an antenna structure according to an embodiment of the invention;

FIG. 3 is a perspective view of a convertible mobile device operating in a notebook mode according to an embodiment of the invention;

FIG. 4 is a perspective view of a convertible mobile device operating in a tablet mode according to an embodiment of the invention;

FIG. 5 is a diagram of return loss of an antenna structure when a convertible mobile device operates in a notebook mode according to an embodiment of the invention;

FIG. 6 is a diagram of return loss of an antenna structure when a convertible mobile device operates in a tablet mode according to an embodiment of the invention; and

FIG. 7 is a top view of an antenna structure according to an embodiment of the invention.

### DETAILED DESCRIPTION OF THE INVENTION

In order to illustrate the purposes, features and advantages of the invention, the embodiments and figures of the invention are shown in detail as follows.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Furthermore, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

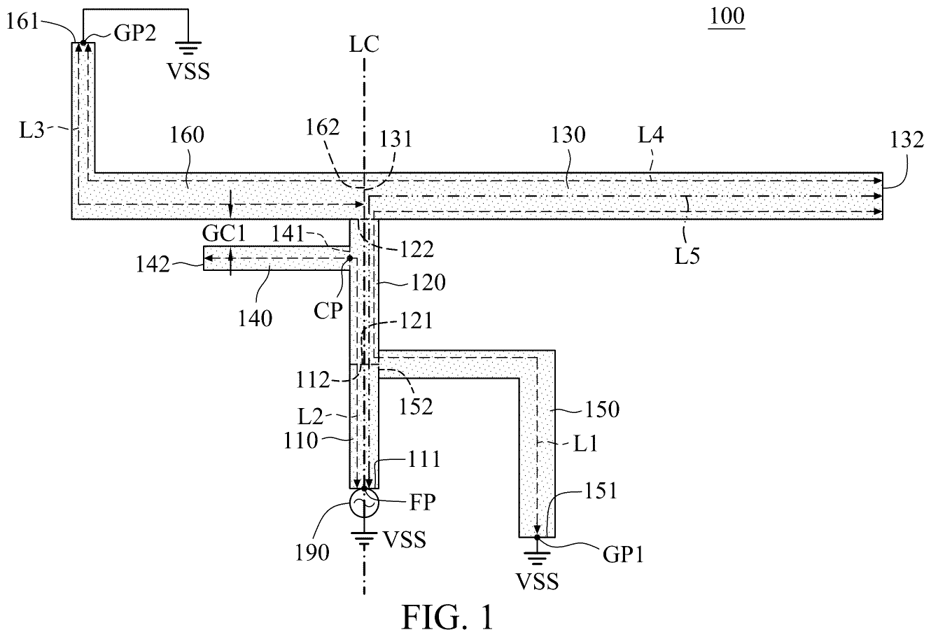

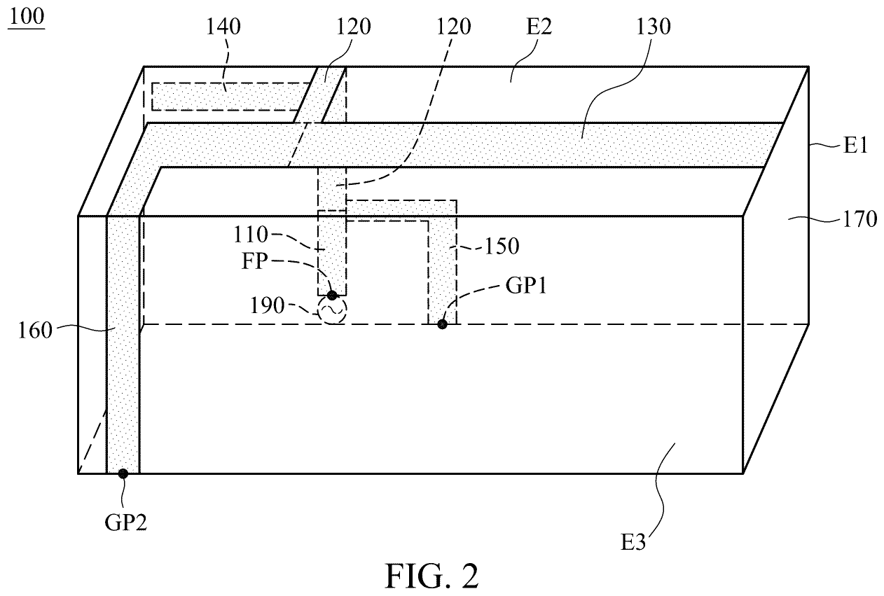

FIG. 1 is a flat view of an antenna structure 100 according to an embodiment of the invention. FIG. 2 is a perspective view of the antenna structure 100 according to an embodiment of the invention. Please refer to FIG. 1 and FIG. 2 together. The antenna structure 100 may be applied to a mobile device, such as a smart phone, a tablet computer, or a notebook computer. In the embodiment of FIG. 1 and FIG. 2, the antenna structure 100 includes a feeding radiation element 110, a connection radiation element 120, a first radiation element 130, a second radiation element 140, a first shorting radiation element 150, a second shorting radiation element 160, and a carrier element 170. The feeding radiation element 110, the connection radiation element 120, the first radiation element 130, the second radiation element 140, the first shorting radiation element 150, and the second shorting radiation element 160 may all be made of metal materials, such as copper, silver, aluminum, iron, or their alloys.

The feeding radiation element 110 has a first end 111 and a second end 112. A feeding point FP is positioned at the first end 111 of the feeding radiation element 110. The feeding point FP may be further coupled to a signal source 190. For example, the signal source 190 may be an RF (Radio Frequency) module for exciting the antenna structure 100. In some embodiments, the feeding radiation element 110 substantially has a straight-line shape, but it is not limited thereto.

The connection radiation element 120 has a first end 121 and a second end 122. The first end 121 of the connection radiation element 120 is coupled to the second end 112 of the feeding radiation element 110. In some embodiments, the feeding radiation element 110 and the connection radiation element 120 are substantially arranged in the same partition line LC. The first radiation element 130 and the first shorting radiation element 150 may be positioned at the same side (e.g., the right side) of the partition line LC. The second radiation element 140 and the second shorting radiation element 160 may be positioned at the opposite side (e.g., the left side) of the partition line LC. It should be understood that the partition line LC may be a straight line on a plane, but the partition line LC may be appropriately bent according to different requirements. In some embodiments, the connection radiation element 120 substantially has another straight-line shape, but it is not limited thereto.

The first radiation element 130 has a first end 131 and a second end 132. The first end 131 of the first radiation element 130 is coupled to the second end 122 of the connection radiation element 120. The second end 132 of the first radiation element 130 is an open end. In some embodiments, the first radiation element 130 substantially has a relatively long straight-line shape, which is substantially perpendicular to the connection radiation element 120, but it is not limited thereto.

The second radiation element 140 has a first end 141 and a second end 142. The first end 141 of the second radiation element 140 is coupled to a connection point CP on the connection radiation element 120. The second end 142 of the second radiation element 140 is an open end. For example, the second end 142 of the second radiation element 140 and the second end 132 of the first radiation element 130 may substantially extend in opposite directions and away from each other. Also, the connection point CP may be adjacent to the second end 122 of the connection radiation element 120. In some embodiments, the second radiation element 140 substantially has a relatively short straight-line shape, which is substantially perpendicular to the connection radiation element 120 and is substantially parallel to the first radiation element 130, but it is not limited thereto. It should be noted that the term “adjacent” or “close” over the disclosure means that the distance (spacing) between two corresponding elements is smaller than a predetermined distance (e.g., 10 mm or the shorter), but often does not mean that the two corresponding elements directly touch each other (i.e., the aforementioned distance/spacing between them is reduced to 0).

The first shorting radiation element 150 has a first end 151 and a second end 152. A first grounding point GP1 is positioned at the first end 151 of the first shorting radiation element 150. The second end 152 of the first shorting radiation element 150 is coupled to the second end 112 of the feeding radiation element 110 and the first end 121 of the connection radiation element 120. That is, both the feeding radiation element 110 and the connection radiation element 120 are coupled through the first shorting radiation element 150 to the first grounding point GP1. The first grounding point GP1 is also coupled to a ground voltage VSS. For example, the ground voltage VSS may be provided by a system ground plane (not shown) of the antenna structure 100. In some embodiments, the first shorting radiation element 150 substantially has a relatively short L-shape, but it is not limited thereto.

The second shorting radiation element 160 has a first end 161 and a second end 162. A second grounding point GP2 is positioned at the first end 161 of the second shorting radiation element 160. The second end 162 of the second shorting radiation element 160 is coupled to the second end 122 of the connection radiation element 120 and the first end 131 of the first radiation element 130. That is, both the connection radiation element 120 and the first radiation element 130 are coupled through the second shorting radiation element 160 to the second grounding point GP2. The second grounding point GP2 is also coupled to the ground voltage VSS. The second grounding point GP2 may be completely different from the aforementioned first grounding point GP1. In addition, the second shorting radiation element 160 may be adjacent to the second radiation element 140, and a coupling gap GC1 may be formed between the second shorting radiation element 160 and the second radiation element 140. In some embodiments, the second shorting radiation element 160 substantially has a relatively long L-shape, but it is not limited thereto.

For example, the carrier element 170 may be implemented with a nonconductive support element or a speaker element. The feeding radiation element 110, the connection radiation element 120, the first radiation element 130, the second radiation element 140, the first shorting radiation element 150, and the second shorting radiation element 160 are all distributed over the carrier element 170. Specifically, the carrier element 170 has a first surface E1, a second surface E2, and a third surface E3. The third surface E3 is opposite to the first surface E1. The second surface E2 is positioned between the first surface E1 and the third surface E3. In some embodiments, the feeding point FP and the first grounding point GP1 are positioned on the same surface (e.g., the first surface E1) of the carrier element 170, and the second grounding point GP2 is positioned on another surface of the carrier element 170. The feeding radiation element 110, the second radiation element 140, and the first shorting radiation element 150 may all be disposed on the first surface E1 of the carrier element 170. The first radiation element 130 may be disposed on the second surface E2 of the carrier element 170. The connection radiation element 120 may extend from the first surface E1 onto the second surface E2 of the carrier element 170. The second shorting radiation element 160 may extend from the second surface E2 onto the third surface E3 of the carrier element 170. In some embodiments, the carrier element 170 substantially has a cuboid shape. It should be noted that the invention is not limited thereto. In alternative embodiments, the feeding radiation element 110, the connection radiation element 120, the first radiation element 130, the second radiation element 140, the first shorting radiation element 150, the second shorting radiation element 160 are positioned on different surfaces of the carrier element 170, and they are adjustable according to a variety of design requirements. In alternative embodiments, at least one portion of the feeding radiation element 110 and at least one portion of the first shorting radiation element 150 are positioned on the same surface (e.g., the first surface E1) of the carrier element 170, and at least one portion of the second shorting radiation element 160 is positioned on another surface (i.e., the surface other than the first surface E1) of the carrier element 170.

It should be understood that although the antenna structure 100 is a 3D (Three-Dimensional) antenna structure, the invention is not limited thereto. In alternative embodiments, the antenna structure 100 is modified to a planar antenna structure (as shown in FIG. 1), without affecting its radiation performance. Furthermore, if the carrier element 170 is a speaker element, the aforementioned radiation elements may be distributed over a nonconductive housing of the speaker element, thereby minimizing the whole size of the antenna structure 100.

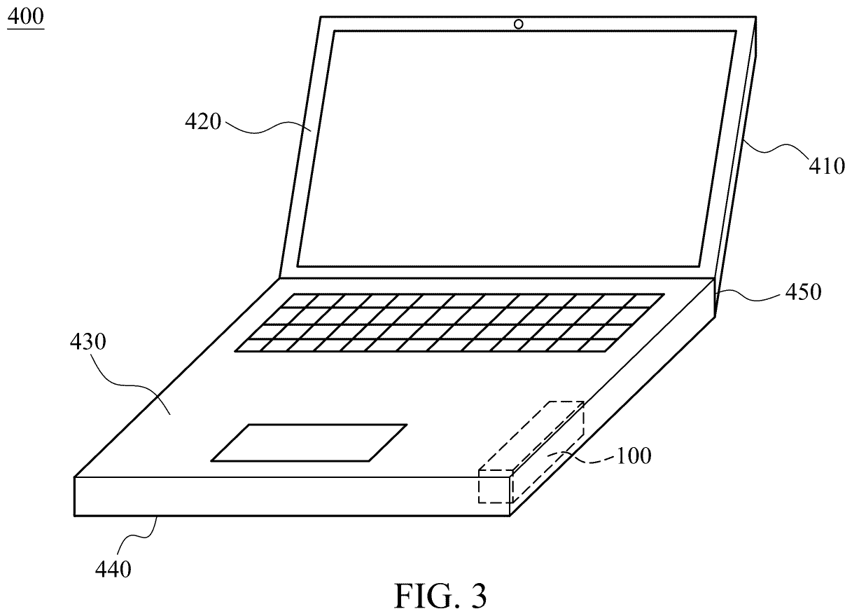

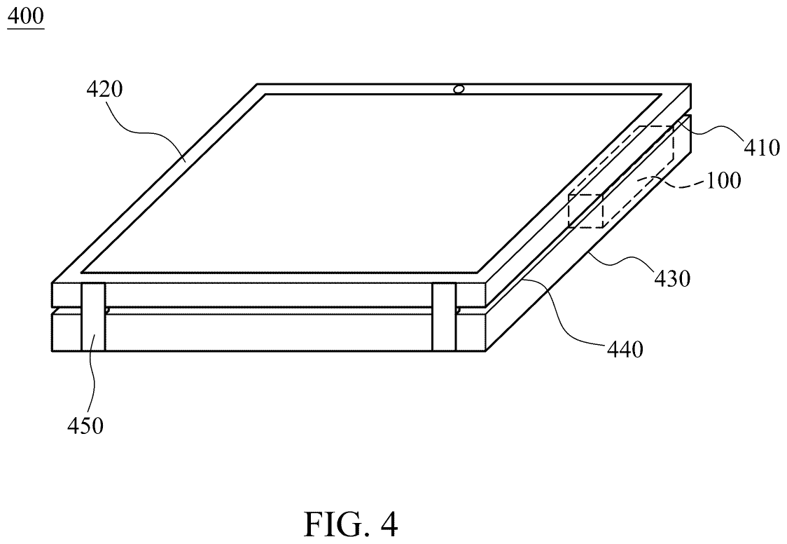

FIG. 3 is a perspective view of a convertible mobile device 400 operating in a notebook mode according to an embodiment of the invention. FIG. 4 is a perspective view of the convertible mobile device 400 operating in a tablet mode according to an embodiment of the invention. Please refer to FIG. 3 and FIG. 4 together. In the embodiment of FIGS. 3 and 4, the convertible mobile device 400 includes an upper cover housing 410, a display frame 420, a keyboard frame 430, a base housing 440, and a hinge element 450. The keyboard frame 430 and the base housing 440 may be made of metal materials. It should be understood that the upper cover housing 410, the display frame 420, the keyboard frame 430, and the base housing 440 are respectively equivalent to the so-called “A-component”, “B-component”, “C-component”, and “D-component” in the field of notebook computers. The convertible mobile device 400 can be switchable between the notebook mode and the tablet mode by using the hinge element 450. For example, the aforementioned antenna structure 100 may be disposed between the keyboard frame 430 and the base housing 440, but it is not limited thereto. In some embodiments, the base housing 440 further has an antenna window (not shown) corresponding to the aforementioned antenna structure 100, such that electromagnetic waves of the antenna structure 100 can be transmitted through the antenna window.

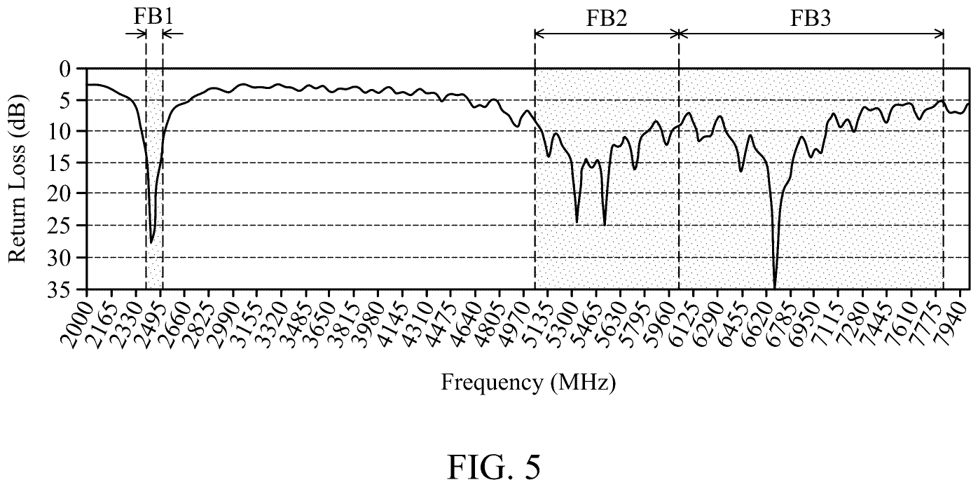

FIG. 5 is a diagram of return loss of the antenna structure 100 when the convertible mobile device 400 operates in the notebook mode according to an embodiment of the invention. The horizontal axis represents the operational frequency (MHz), and the vertical axis represents the return loss (dB). According to the measurement of FIG. 5, the antenna structure 100 can cover a first frequency band FB1, a second frequency band FB2, and a third frequency band FB3. For example, the first frequency band FB1 may be from 2400 MHz to 2500 MHz, the second frequency band FB2 may be from 5000 MHz to 6000 MHz, and the third frequency band FB3 may be from 6000 MHz to 7800 MHz. Therefore, the antenna structure 100 can support at least the wideband operations of the conventional WLAN (Wireless Local Area Network) and the next-generation Wi-Fi 6E.

In some embodiments, when the convertible mobile device 400 operates in the notebook mode, the operational principles of the antenna structure 100 may be described as follows. The first shorting radiation element 150, the connection radiation element 120, and the first radiation element 130 can be excited to generate the first frequency band FB1. The feeding radiation element 110, the connection radiation element 120, and the second radiation element 140 can be excited to generate the second frequency band FB2. In addition, the second shorting radiation element 160 can be excited by the second radiation element 140 using a coupling mechanism, so as to generate the third frequency band FB3.

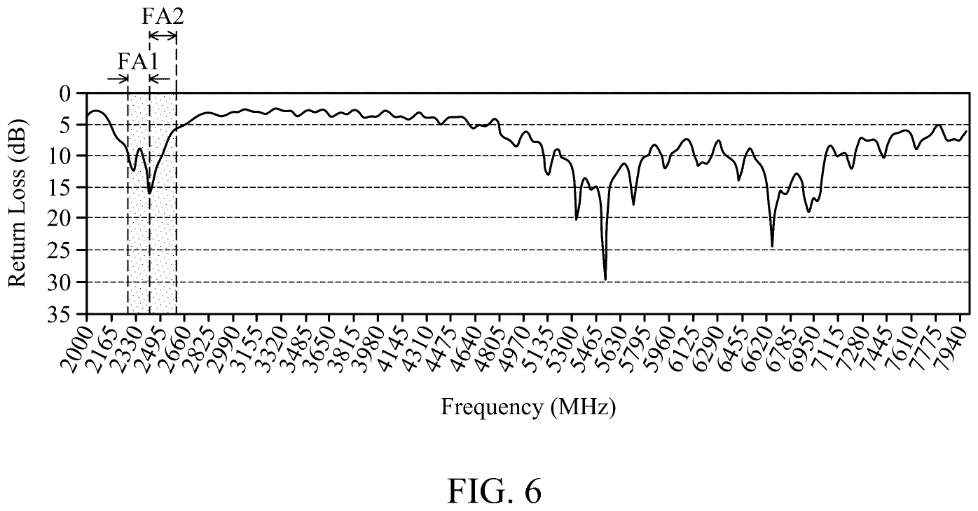

FIG. 6 is a diagram of return loss of the antenna structure 100 when the convertible mobile device 400 operates in the tablet mode according to an embodiment of the invention. The horizontal axis represents the operational frequency (MHz), and the vertical axis represents the return loss (dB). According to the measurement of FIG. 6, in the tablet mode, the antenna structure 100 can further cover a first auxiliary frequency band FA1 and a second auxiliary frequency band FA2. For example, the first auxiliary frequency band FA1 may be from 2300 MHz to 2450 MHz, and the second auxiliary frequency band FA2 may be from 2450 MHz to 2600 MHz. It should be noted that when the convertible mobile device 400 is switched from the notebook mode to the tablet mode, the aforementioned first frequency band FB1 of the antenna structure 100 is replaced with the first auxiliary frequency band FA1 and the second auxiliary frequency band FA2. The combination of the first auxiliary frequency band FA1 and the second auxiliary frequency band FA2 can provide a relatively large low-frequency bandwidth. In addition, the antenna structure 100 can still support the second frequency band FB2 and the third frequency band FB3 as mentioned above.

In some embodiments, when the convertible mobile device 400 operates in the tablet mode, the operational principles of the antenna structure 100 may be described as follows. The second shorting radiation element 160 and the first radiation element 130 can be excited to generate the first auxiliary frequency band FA1. The feeding radiation element 110, the connection radiation element 120, and the first radiation element 130 can be excited to generate the second auxiliary frequency band FA2. According to practical measurements, the incorporation of the second shorting radiation element 160 can be used to fine-tune the impedance matching of the first frequency band FB1 (or the first auxiliary frequency band FA1 and the second auxiliary frequency band FA2), the second frequency band FB2, and the third frequency band FB3. Thus, the antenna structure 100 can provide a sufficient operational bandwidth regardless of the convertible mobile device 400 operating in the notebook mode or the tablet mode. In alternative embodiments, the antenna structure 100 is used independently, and it is not necessary to combine the antenna structure 100 with the convertible mobile device 400.

In some embodiments, the element sizes of the antenna structure 100 will be described as follows. The total length L1 of the first shorting radiation element 150, the connection radiation element 120, and the first radiation element 130 may be substantially equal to 0.25 wavelength (λ/4) of the first frequency band FB1 of the antenna structure 100. The total length L2 of the feeding radiation element 110, the connection radiation element 120, and the second radiation element 140 may be substantially equal to 0.25 wavelength (λ/4) of the second frequency band FB2 of the antenna structure 100. The length L3 of the second shorting radiation element 160 may be substantially equal to 0.25 wavelength (λ/4) of the first frequency band FB1 of the antenna structure 100. The total length L4 of the second shorting radiation element 160 and the first radiation element 130 may be substantially equal to 0.25 wavelength (λ/4) of the first auxiliary frequency band FA1 of the antenna structure 100. The total length L5 of the feeding radiation element 110, the connection radiation element 120, and the first radiation element 130 may be substantially equal to 0.25 wavelength (λ/4) of the second auxiliary frequency band FA2 of the antenna structure 100. The width of the coupling gap GC1 may be greater than 0 mm and may be smaller than or equal to 3 mm. The above ranges of element sizes are calculated and obtained according to many experiment results, and they help to optimize the operational bandwidth and impedance matching of the antenna structure 100 used for the convertible mobile device 400 operating in both the notebook mode and the tablet mode.

The following embodiments will introduce different configurations and detailed structural features of the antenna structure 100. It should be understood that these figures and descriptions are merely exemplary, rather than limitations of the invention.

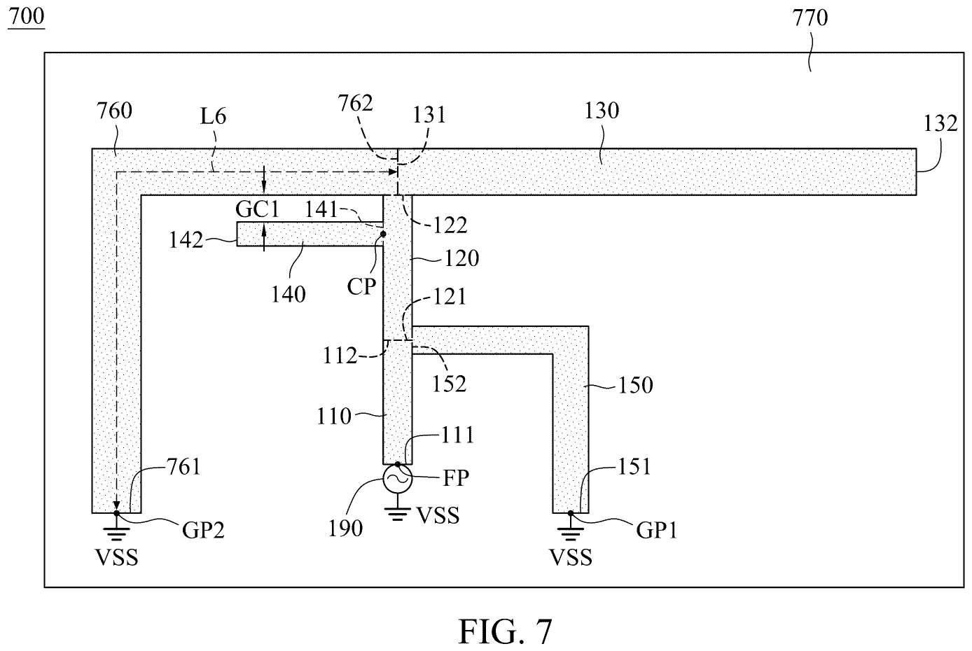

FIG. 7 is a top view of an antenna structure 700 according to an embodiment of the invention. FIG. 7 is similar to FIG. 1. In the embodiment of FIG. 7, the antenna structure 700 is a planar antenna structure, and a carrier element 770 of the antenna structure 700 is implemented with a PCB (Printed Circuit Board). Furthermore, a second shorting radiation element 760 of the antenna structure 700 has a first end 761 and a second end 762, and a second grounding point GP2 is positioned at the first end 761 of the second shorting radiation element 760. As a whole, the first grounding point GP1 and the second grounding point GP2 of the antenna structure 700 may be symmetrical to each other with respect to the feeding radiation element 110 therebetween. Similarly, the length L6 of the second shorting radiation element 760 may be substantially equal to 0.25 wavelength (λ/4) of the first frequency band FB1 of the antenna structure 700. Other features of the antenna structure 700 of FIG. 7 are similar to those of the antenna structure 100 of FIG. 1. Therefore, the two embodiments can achieve similar levels of performance.

The invention proposes a novel antenna structure. In comparison to the conventional design, the invention has at least the advantages of small size, wide bandwidth, good communication quality, and compatibility with a convertible mobile device operating in different modes. Therefore, the invention is suitable for application in a variety of communication devices.

Note that the above element sizes, element shapes, and frequency ranges are not limitations of the invention. An antenna designer can fine-tune these settings or values in order to meet specific requirements. It should be understood that the antenna structure of the invention is not limited to the configurations depicted in FIGS. 1-7. The invention may merely include any one or more features of any one or more embodiments of FIGS. 1-7. In other words, not all of the features displayed in the figures should be implemented in the antenna structure of the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An antenna structure, comprising:
a feeding radiation element, having a feeding point;
a connection radiation element, coupled to the feeding radiation element;
a first radiation element, coupled to the connection radiation element;
a second radiation element, coupled to the connection radiation element, wherein the second radiation element and the first radiation element substantially extend in opposite directions;
a first shorting radiation element, wherein the feeding radiation element and the connection radiation element are coupled through the first shorting radiation element to a first grounding point;
a second shorting radiation element, disposed adjacent to the second radiation element, wherein the connection radiation element and the first radiation element are coupled through the second shorting radiation element to a second grounding point; and
a carrier element, wherein the feeding radiation element, the connection radiation element, the first radiation element, the second radiation element, the first shorting radiation element, and the second shorting radiation element are distributed over the carrier element.

2. The antenna structure as claimed in claim 1, wherein the carrier element is implemented with a nonconductive support element, a speaker element, or a PCB (Printed Circuit Board).

3. The antenna structure as claimed in claim 1, wherein the carrier element substantially has a cuboid shape.

4. The antenna structure as claimed in claim 1, wherein the carrier element has a first surface, a second surface and a third surface, the third surface is opposite to the first surface, and the second surface is positioned between the first surface and the third surface.

5. The antenna structure as claimed in claim 4, wherein the feeding point and the first grounding point are disposed on a same surface of the carrier element.

6. The antenna structure as claimed in claim 5, wherein the second grounding point is disposed on another surface of the carrier element.

7. The antenna structure as claimed in claim 4, wherein the feeding radiation element, the second radiation element, and the first shorting radiation element are disposed on the first surface of the carrier element, wherein the first radiation element is disposed on the second surface of the carrier element, wherein the connection radiation element extends from the first surface onto the second surface of the carrier element, and wherein the second shorting radiation element extends from the second surface onto the third surface of the carrier element.

8. The antenna structure as claimed in claim 1, wherein a coupling gap is formed between the second shorting radiation element and the second radiation element, and a width of the coupling gap is greater than 0 mm and is smaller than or equal to 3 mm.

9. The antenna structure as claimed in claim 1, wherein the feeding radiation element and the connection radiation element are substantially arranged in a partition line.

10. The antenna structure as claimed in claim 9, wherein the first radiation element and the first shorting radiation element are positioned at a side of the partition line, and the second radiation element and the second shorting radiation element are positioned at an opposite side of the partition line.

11. The antenna structure as claimed in claim 1, wherein the antenna structure covers a first frequency band, a second frequency band, and a third frequency band.

12. The antenna structure as claimed in claim 11, wherein the first frequency band is from 2400 MHz to 2500 MHz, the second frequency band is from 5000 MHz to 6000 MHz, and the third frequency band is from 6000 MHz to 7800 MHz.

13. The antenna structure as claimed in claim 11, wherein a total length of the first shorting radiation element, the connection radiation element, and the first radiation element is substantially equal to 0.25 wavelength of the first frequency band.

14. The antenna structure as claimed in claim 11, wherein a total length of the feeding radiation element, the connection radiation element, and the second radiation element is substantially equal to 0.25 wavelength of the second frequency band.

15. The antenna structure as claimed in claim 11, wherein a length of the second shorting radiation element is substantially equal to 0.25 wavelength of the first frequency band.

16. The antenna structure as claimed in claim 11, wherein the antenna structure further covers a first auxiliary frequency band and a second auxiliary frequency band.

17. The antenna structure as claimed in claim 16, wherein the first auxiliary frequency band is from 2300 MHz to 2450 MHz, and the second auxiliary frequency band is from 2450 MHz to 2600 MHz.

18. The antenna structure as claimed in claim 16, wherein a total length of the second shorting radiation element and the first radiation element is substantially equal to 0.25 wavelength of the first auxiliary frequency band.

19. The antenna structure as claimed in claim 16, wherein a total length of the feeding radiation element, the connection radiation element, and the first radiation element is substantially equal to 0.25 wavelength of the second auxiliary frequency band.

20. The antenna structure as claimed in claim 1, wherein the antenna structure is applied in a convertible mobile device, and the convertible mobile device selectively operates in a notebook mode or a tablet mode.
